(19) United States
(12) Patent Application Publication
(10) Pub. No.: US 2024/0048402 A1
(43) Pub. Date: Feb. 8, 2024

(54) MODULAR SMART HOME GATEWAY SYSTEM

(71) Applicant: Butler at Your Service, Burnaby (CA)

(72) Inventors: Kevin Gu, Burnaby (CA); Hamed Noori, Burnaby (CA); Gary Cheng, Burnaby (CA)

(73) Assignee: Butler at Your Service, Burnaby (CA)

(21) Appl. No.: 18/230,748

(22) Filed: Aug. 7, 2023

Related U.S. Application Data
(60) Provisional application No. 63/396,157, filed on Aug. 8, 2022.

(51) Int. Cl. H04L 12/28

(52) U.S. Cl. CPC H04L 12/2825

(57) ABSTRACT

A modular hardware solution for a smart home gateway that can support multiple communication protocols with different functionalities. The smart home gateway is modular in nature, and the associated modules, units, and components can be installed, modified, or removed easily on the base board. The processing unit integrated is equipped with multi-thread firmware that allows seamless transition of connection among multiple available communication protocols. Communication modules can be integrated through terminal interfaces that would provide additional connectivity to other home devices. Home devices in a smart home setting would not need to be uniformed configured, as the smart home gateway would be configured to harmoniously interact with all devices in a smart home setting. The smart home gateway module incorporates an user interface that is accessible through personal devices by authorized users, and can provide continuous update and enable uninterrupted control over the home devices on the network.

### CROSS REFERENCE TO RELATED APPLICATION

This application claims the benefit under 35 U.S.C. § 119(e) of U.S. Provisional Application No. 63/396,157 entitled “MODULAR SMART HOME GATEWAY SYSTEM” filed Aug. 8, 2022, which is incorporated herein by reference.

### BACKGROUND

Smart home architecture and framework have become increasingly popular and sophisticated, and the need for a reliable hub to manage the various smart devices in a home has increased as a result. While many devices adhere to a certain standard of connectivity, there is no requirement for all devices to be automatically set to the proper connection protocol in a home. In the scenario when a home experiences power, internet, or service interruption, this could prompt untimely reset in the interconnectivity of devices. Without an automated connectivity hub to monitor and manage various devices, users could be overwhelmed by potential need to individually reset each connection.

There exists a need for a smart home platform that can be assembled, managed, and modified, without overhauling the connection inside a smart home constantly. As smart home design advances and increasing number of devices is added to a home constantly, there exist a need for a modular smart home hub that allows a user to add, remove, and change components in a convenient manner.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

A hardware solution for a smart home is provided. The system utilizes a gateway or hub that can support multiple communication protocols with different functionalities. The system is modular and includes a gateway that can communicate through multiple communication protocols, such as ZigBee, Z-wave, LoRaWAN, Bluetooth and other similar protocols.

The modular design of the system provides users with the ability to select the modules that can utilize the communication protocol (or protocols) that are necessary for their device (or devices). As a result, users can select the modules that they need and do need to use modules for devices that they do not have.

The system functions independently of the module(s) that is(are) installed by utilizing hardware and firmware that can process messages based upon the protocol that is used by the installed devices. The system functions based upon the modules that are utilized.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is an embodiment of the modular smart home gateway system.

FIG. 2 is an illustration of an application of the modular smart home gateway system.

### DETAILED DESCRIPTION

The present system is a modular hardware solution for a smart home gateway or hub that can support multiple communication protocols with different functionalities.

The gateway base module is equipped with processing units, a Wi-Fi unit, LAN unit, a Cellular unit, a power control unit, and five terminals for external modules. The gateway uses Wi0Fi, Cellular, and LAN for backhaul connectivity to the cloud server.

The gateway can be expanded with five additional modules that can be added to the base hardware. These modules include: security module, ZigBee module, z-wave module, LoRaWAN module, and Bluetooth module.

The gateway is designed to have a fully functional modular board layout that allows every module to be integrated or removed as needed. Users do not need to utilize all protocols and can pick and choose modules, as needed.

The base processing unit is responsible for the detection of the integrated modules and runs the firmware that corresponds with the integrated modules. The gateway can be controlled with a smartphone app or web application. The gateway base module continuously searches for and detects any Wi-Fi sensors in the area or home to connect and if the sensors are registered with the App, the gateway sends and receives the sensor data and transfers it to the cloud.

If a security module is integrated, the gateway can control the home security alarm system, either wired or wireless, and if any incident happens, the device will notify the security team, call center, mobile app, etc.

If either a ZigBee module, a Z-wave module, a LoRaWAN module, and a Bluetooth module are integrated, the gateway continuously searches for any sensors with integrated connectivity in the area or home to connect. If the sensors are registered with the App, the gateway sends and receives the sensor data and transfers it to the cloud.

A multi-threaded processing firmware for simultaneously sending and receiving data with various communication protocols, integrating and merging the data and transferring the data to the cloud in real-time while minimizing the interference between all the communication modules.

The gateway is capable of edge-processing and can use the collected data to make decisions (such as fire detection, burglary detection, water leakage detection, gas leakage detection) and send instructions or commands (such as heating/cooling control, water/gas valve actuator, and lighting control) to sensors and actuators that are connected to it.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

The system provides a platform that can automatically detect the proper communication protocol, and allow devices to be monitored and managed without the need to individually synch each device. With the system connected to a cloud server, the present system allows a user to check on the status of the device on the in home network remotely. The information being processed in the cloud server provides a high level of mobility to the device data associated with the networked devices.

The base gateway module can be configured to perform a basic level of management function without requiring any external module. A user can choose to connect communication modules to the base gateway module to expand on its functionality. With increased number of communication modules being added, the base gateway module can detect and establish reliable communication with the devices on the network their respective communication protocol.

The invention is a smart home gateway that can support multiple communication protocols at the same time. In some embodiments, the gateway can support six or more communication protocols at the same time.

A component integrated onto the module can be configured to communicate through a particular communication protocol When a user elects to integrate another module the base gateway module would direct communications to the device through the designated protocol. Other devices connected to the network do not need to be configured to particular protocol, as the smart home gateway would detect the appropriate communication channel automatically.

In an example, the smart home gateway solution provides a modular board configured to receive several components or modules. The modular board provides power to each modular component when they are installed and will establish communication between the installed components in order to perform the necessary functions. As an example for a basic configuration, a user equips the gateway base module with a processing unit, a wireless connection (wi-fi) unit, a local area network (LAN) unit, and a cellular service unit. These three units would be considered a collection of network units, and would grant access to other devices connected through each protocol. The modular board also is equipped with a power control unit, such that appropriate power can be supplied to each of the installed modules.

In this example of basic configuration, the gateway module is set up to communicate with devices connected to any of the detectable networks, through either Wi-Fi, LAN, or cellular services. The network units would each be configured to communicate with the respectively connected devices in the home, and the processing unit would enable the gateway module to connect to all three simultaneously in a harmonious manner. Additionally, the gateway would utilize any or all of the connection for backhaul connectivity to the cloud server.

The gateway module enables robust interconnectivity of multiple devices by operating directly through a cloud server, and the network units provide the means for the gateway module to reach the cloud server through numerous methods. The backhaul connectivity provides a stable connection that would not impact device operation, should any of the network drops out. The processing unit is configured to manage dataflow and connectivity protocol selection automatically. Alternatively, a user can issue instructions to the gateway module to communicate through specific communication protocols.

In addition to the network units that can be integrated to the base gateway module board, a user has the option to connect communication modules to the board. In the exemplary embodiment, the gateway module board is equipped with five terminals for communication modules. The terminals are modular by nature, as well, and can be installed, modified, and removed from the board as needed. Once installed, these external terminals allow communication modules to be connected. Once connected, the processing unit will be able to access the communication modules in the same manner as it does with the integrated network units.

Each terminal allows a communication module to be added as an expansion of the hardware. Examples of the modules include: security module, ZigBee module, z-wave module, LoRaWAN module, and Bluetooth module. This is not an exhaustive list of communication modules that would be compatible with the modular board, and a person with ordinary skills in the art would be equipped to utilize any of the connectivity technologies available at the time.

The gateway is designed to have a fully functional modular board layout that allows every module to be integrated or removed as needed. The communication modules and the network units can be viewed as part of the same gateway module, with the communication modules being connected through additional hardware instead of the board itself. The modular nature of the gate provides an enhanced level of customizability and upgradability.

The base processing unit is responsible for the detection of the integrated modules and runs the firmware that corresponds with the integrated modules. The integrated modules would include both modules added to the base board as well as those communication modules that can be connected through the terminals. The processing unit can be further supplemented with multiple processing units, such that additional firmware can be installed for seamless transition in connectivity and communication.

The gateway is available with user interfaces that can be accessed through a variety of devices. In an exemplary embodiment, a smart phone application can be used to access the interface and manage the operation of the gateway. In another exemplary embodiment, the interface can be accessed through a web based application. Users can interact with the gateway through these interfaces on any of the standard application programming interface available on the market.

The processing unit would manage the user experience and issue instructions to the respective integrated and integrated modules of the board. As devices are connected to each of the communication protocol, the gateway unit would allow communication to these devices through the integrated modules.

The gateway base module continuously searches for and detects any Wi-Fi sensors in the area or home to connect and if the sensors are registered with the App, the gateway sends and receives the sensor data and transfers it to the cloud. This enables continuous backup data to the cloud server, as long as the gateway base module is able to detect network connection through its network units. It is envisioned that the connection to the cloud server can be achieved as long as any network units can be reached.

In one exemplary embodiment, a security module is integrated onto the gateway base module through one of its terminals. When the security module is integrated, the gateway can control the home security alarm system. The security module can connect to the security devices in the house through wired or wireless connections. The security module's integration allows the gateway module to monitor and control these networked security devices directly. Therefore, should the security devices detect any incidents, the gateway module can contact appropriate teams, if set up to do so. In one example, the security module would prompt the gateway module to notify the owner of the home or any of the authorized users, the security team, or appropriate call centers. In one instance, the gateway module would receive information from the connected security devices on the network and transmit such data to the user interface on a user's personal computer device. The user can then choose to authorize further actions to the gateway module.

In one exemplary embodiment, the gateway module is integrated with a ZigBee module, Z-wave module, LoRaWAN module, and Bluetooth module. This configuration allows the gateway to continuously search for any sensors with integrated connectivity in the area or home to connect. As a hub of the smart home system, the gateway module is intended to integrate all available connectable devices in the home. As in the security module example above, the gateway module is able to interface with any devices connected through wired or wireless means. In this example, the gateway module is further configured to continuously search for sensors and devices on any of the ZigBee, Z-Wave, LoRaWAN, or Bluetooth networks. If the sensors and devices are registered with the App, the gateway sends and receives the sensor data and transfers it to the cloud. The data can be transferred to the cloud as long as the gateway can reach the cloud through any of the connections secured by the network units.

In the exemplary embodiment, the gateway module can be configured to send instructions to actuator components of each of the connected devices. This would enable each authorized user to activate devices on the smart home network remotely.

It is envisioned that the present system is embed with a multi-threaded processing firmware for simultaneously sending and receiving data with various communication protocols, integrating and merging the data and transferring the data to the cloud in real-time while minimizing the interference between all the communication modules. A user can choose to set preferences on the communication protocols in their interaction with the gateway module. The module can further be configured to seamlessly switch between the various communication protocols to maintain an uninterrupted connection to the cloud server. This would enhance reliability of the smart home network and minimize contact gap in the network.

The gateway is capable of edge-processing and can use the collected data to make decisions automatically. In one example, should a fire detection device reach an alert threshold, the gateway module would be able to identify the alert trigger and automatically engage in appropriate actions. This could include contacting and alerting the authorized user, contacting and alerting the appropriate authorities, or issuing commands to the safety measure devices connected to the network. Such decision making capability is achieved through the collection of processing units integrated on to gateway module. Alternatively, such decision making capability would be imbued in a device located on the cloud server.

There are other triggering events that would prompt actions aligned with the decision making capability of the gateway module. Some of the examples include burglary, water leakage, gas leak, etc. During these events, the gateway module would be configured to issue instructions or commands to the connected devices on the network, either automatically or through authorization of users.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

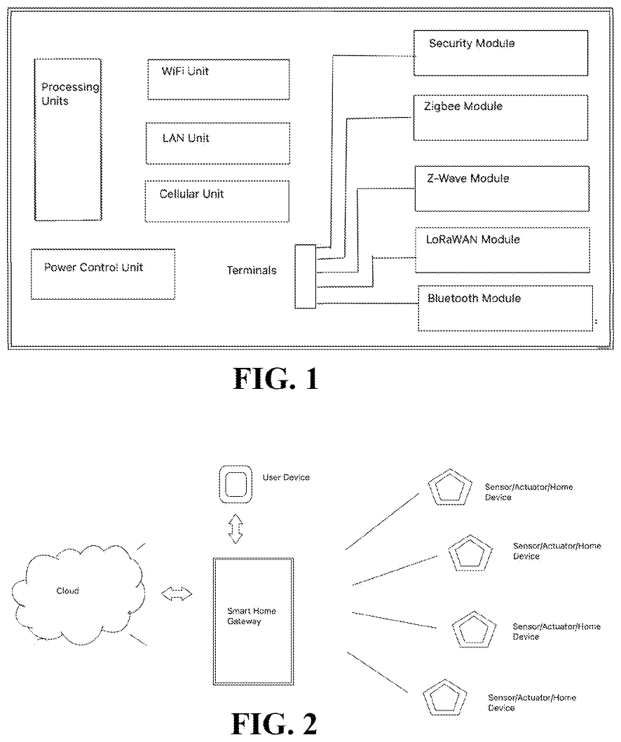

Referring to FIG. 1, an exemplary embodiment of the smart home gateway module system is illustrated.

The gateway base module is shown to have integrated a collection of processing units, a power control unit, and a trio of network units. The network units in this example are the Wi-Fi unit, local area network (LAN) network, and the cellular network unit. The processing unit is configured with multi threaded firmware to interact with each of the network units automatically. The network units would allow the gateway module to be connected to a cloud server continuously, should any of the network unit be able to connect to the cloud server. The processing units are able to switch between each network unit seamlessly as needed.

The power control unit supplies power to both the processing units and the networking units. Additional components can be added to supplement the power control units to ensure a continuous and uninterrupted power source for the integrated modules and units on the gateway module. In an exemplary scenario, backup power supply could be used to supplement the power control unit.

An array of terminals is integrated into the gateway module to allow connection to communication modules. The terminals are modular in nature, as with every module associated in the present system, so that each individual terminal can be installed, modified, and removed as needed. Connected to the terminals are a collection of communication modules. In this illustrated example, the communication modules are the security module, the ZigBee module, the Z-Wave module, the LoRaWAN module, and the Bluetooth module.

These communication modules are integrated into the gateway module through external connection. However, they would be controlled and made to function in the same way that other modules installed on the base board would. Each communication module is configured to interact with a particular communication protocol. The processing module would be instructed to continuously search through each module for sensors, devices, or actuators connected through each respective communication protocol. In a smart home environment, the individual sensors and devices do not need to conform to a singular communication module. Instead, the gateway module would be managed and modified to interact with each additional module in the separate communication protocol as needed.

Referring to FIG. 2, an exemplary application utilizing the smart home gateway module is illustrated.

A smart home gateway, with all the integrated modules as shown in FIG. 1, is set up in a home with a number of sensors, actuators, and home devices. The home devices are equipped to send and receive data through any of the communication protocols that are common seen in the market. As an example, the home devices can be set up to send and receive data through ZigBee, Z-Wave, LoRaWAN, or Bluetooth networks. Alternatively, they could be connected in the smart home through wired connections. These devices do not need to be configured for uniform communication protocols, as the smart home gateway would be configured to connect with them through their intended connectivity mode.

At least one user device is connected to the smart home gateway, and any authorized user can use this user device to access the control interface of the smart home gateway. In this exemplary scenario, the user device is equipped with a phone based app that is configured to interact with the gateway module. The interface is set up to display data supplied by the home devices, and would allow authorized control to these devices through their preferred communication module.

The smart home module utilizes a number of network units, integrated therein, to maintain continuous connection with a cloud server. The cloud server receives the data from the home device, sent to the smart home module, which in turn is sent to the cloud server. The smart home module maintains a continuous connection with the cloud server, so that the network connected home devices will have uninterrupted back up support on the cloud server.

In operation, the authorized user is able to check on the status of each home device connected to the home. Because the home gateway module continuously scans for available communication protocol, the likelihood of a user being unable to reach the home devices is significantly reduced. The authorized user would be frequently updated with the status of each home device, and can send instructions and commands to direct the function of each home device. As a feature of the home gateway module, the processing units would be able to analyze the received data from devices and go through decision making process in regards to their functions. Should an incident occur that would trigger an alert threshold in any home device, the home gateway module would be alerting the authorized user and/or issue a command to the home device in response. The home gateway module can further configured to contact and alert appropriate external teams and persons in response to these incidents.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A module smart home gateway system, comprising:
a cloud server,
at least one user device connected to the cloud server,
a gateway base module having at least one processing unit, a network connection unit, a power control unit, and at least one external connection terminal, wherein the gateway base module connects to the cloud server through the network connection unit, and
at least one communication module connected to the at least one external connection terminal, wherein the at least one communication module connects to, collects data from, and sends instructions to at least one sensor, at least one actuator, and at least one home device in a building.

2. The system of claim 1, wherein the network connection unit comprises of a wi-fi unit, a local area network unit, and a cellular connection unit.

3. The system of claim 1, wherein the at least one communication module comprises a ZigBee module, a Z-wave module, a LoRaWAN module, a Bluetooth module, and a security module.

4. The system of claim 1, wherein the at least one processing unit runs a firmware that corresponds to the at least one processing unit, the network connection unit, the power control unit, and the at least one external connection terminal, wherein the gateway base module is controlled by the at least one user device.

5. The system of claim 1, wherein the gateway base module controls a home security alarm system through the security module.

6. The system of claim 1, wherein the gateway base module is capable of contacting a security team, caller center, or mobile device through the cloud server, when the at least one processing module detects an incident.

7. The system of claim 1, the gateway base module can utilize at least six communication protocols at the same time.

8. The system of claim 7, the gateway base module can utilize at least seven communication protocols at the same time.

9. A system for modular hardware solution for a smart home gateway, comprising:
a gateway base modular board with a layout that is designed to allow at least one module to be integrated or removed as needed, wherein the at least one module comprises a processing unit, a network connection unit, a power unit, and at least one external connection terminal, wherein the network connection unit is configured to connect to a cloud server, through which at least one home device is connected.

10. The system of claim 9, wherein the at least one external connection terminal is connected to a communication module.

11. The system of claim 10, wherein the communication module is ZigBee module, a Z-wave module, a LoRaWAN module, a Bluetooth module, and a security module.

12. The system of claim 9, wherein the processing unit is configured to have a multi-threaded processing firmware for simultaneously sending and receiving data with at least one communication protocol.

13. The system of claim 9, the gateway modular board can utilize at least six communication protocols at the same time.

14. The system of claim 13, the gateway modular board can utilize at least seven communication protocols at the same time.
